(19) United States
(12) Patent Application Publication
(10) Pub. No.: US 2025/0278304 A1
(43) Pub. Date: Sep. 4, 2025

(54) Clustering Computational Workloads for Efficient Allocation of Hardware Resources

(71) Applicant: Google LLC, Mountain View, CA (US)

(72) Inventors: Chidubem Gibson Arachie, Sunnyvale, CA (US); Michael D. Hutton, Mountain View, CA (US); Vineetha Govindaraj, Mountain View, CA (US); Narges Shahidi, San Jose, CA (US); Ashish Bansal, Mountain View, CA (US); Christoforos Kozyrakis, Palo Alto, CA (US)

(21) Appl. No.: 19/033,882

(22) Filed: Jan. 22, 2025

Related U.S. Application Data
(60) Provisional application No. 63/559,675, filed on Feb. 29, 2024.

(51) Int. Cl. G06F 9/50

(52) U.S. Cl. CPC G06F 9/5027

(57) ABSTRACT

A computing system can evaluate a plurality of respective computational workloads to generate a plurality of respective hardware usage profiles. The computing system can cluster the plurality of respective hardware usage profiles to generate a plurality of workload clusters. The computing system can determine, based at least in part on the plurality of workload clusters, an allocation of computational hardware resources.

### CROSS-REFERENCE TO RELATED APPLICATIONS

The present application is based upon and claims the right of priority to U.S. Provisional Patent Application No. 63/559,675, filed on Feb. 29, 2024, the disclosure of which is hereby incorporated by reference herein in its entirety for all purposes.

### FIELD

The present disclosure relates generally to allocating computational hardware resources for performing computational workloads. More particularly, the present disclosure relates to systems and methods for efficiently allocating computational hardware resources based on clusters of computational workloads.

### BACKGROUND

Computational workloads are typically processed by one or more computing devices comprising a plurality of hardware components (e.g., memory devices, storage devices, communication devices, processor devices for performing arithmetic, etc.). A computing provider may have a plurality of different computing devices having a plurality of different hardware capacities (e.g., floating-point operations per second (FLOPS), memory bandwidth, etc.), along with a plurality (e.g., tens of thousands, etc.) of different computational workloads having different hardware demands. Ad hoc methods for matching computational workloads to hardware resources can lead to suboptimal choices, including suboptimal compilation choices, software design choices, hardware architecture design and acquisition choices, and workload scheduling choices. Suboptimal hardware resource allocations can lead to inefficiencies, such as increased power usage, increased hardware requirements, and reduced computation speed.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include evaluating, by one or more computing devices, a plurality of respective computational workloads to generate a plurality of respective hardware usage profiles. The example method can include clustering, by the one or more computing devices, the plurality of respective hardware usage profiles to generate a plurality of workload clusters. The example method can include determining, by the one or more computing devices based at least in part on the plurality of workload clusters, an allocation of computational hardware resources.

The example method can include outputting, by the one or more computing devices, data indicative of the allocation of computational hardware resources.

The example method can include allocating, by the one or more computing devices, one or more computational hardware resources according to the allocation of computational hardware resources.

In the example method, the allocation of computational hardware resources can include a mapping of a plurality of computational workloads to a plurality of processors.

In the example method, the plurality of processors can include a plurality of application-specific integrated circuits.

In the example method, determining the mapping can include obtaining, by the one or more computing devices, workload cluster data for a plurality of workloads. In the example method, determining the mapping can include obtaining, by the one or more computing devices, hardware availability data for a plurality of processors. In the example method, determining the mapping can include determining, by the one or more computing devices based at least in part on the workload cluster data and the hardware availability data, the mapping.

In the example method, the mapping can map a first plurality of computational workloads to presently existing hardware and can map a second plurality of computational workloads to future hardware. The example method can include determining, by the one or more computing devices based at least in part on one or more workload clusters associated with the second plurality of computational workloads, one or more hardware architecture requirements for running the second plurality of computational workloads.

The example method can include obtaining, by the one or more computing devices, data indicative of a change in a set of workloads to be executed. The example method can include determining, responsive to the change by the one or more computing devices based on the set of workloads to be executed and the plurality of workload clusters, a second allocation of computational hardware resources. The example method can include allocating, by the one or more computing devices according to the second allocation, at least one computational workload to at least one processor device.

In the example method, the allocation of computational hardware resources can include a compilation strategy for compiling one or more computational workloads.

The example method can include obtaining, by the one or more computing devices, a second computational workload. The example method can include compiling, by the one or more computing devices, the second computational workload according to one or more first compilation strategies. The example method can include comparing, by the one or more computing devices, a performance of the compiled second computational workload to a performance associated with one or more second compilation strategies that are different from the one or more first compilation strategies. The example method can include updating, by the one or more computing devices based on the comparison, the compilation strategy for compiling one or more computational workloads.

In the example method, the allocation of computational hardware resources can include a scheduled time for running one or more computational workloads.

In the example method, the allocation of computational hardware resources can include one or more hyperparameter settings associated with one or more computational workloads.

The example method can include determining, by the one or more computing devices based at least in part on the plurality of workload clusters, a respective representative benchmark for each workload cluster of the plurality of workload clusters. In the example method, the allocation of computational hardware resources can be determined based at least in part on at least one respective representative benchmark.

The example method can include parameterizing, by the one or more computing devices, at least one respective representative benchmark. The example method can include performing, by the one or more computing devices based on the parameterized representative benchmark, one or more architectural sensitivity sweeps.

The example method can include testing, by the one or more computing devices using at least one respective representative benchmark, a plurality of compilation strategies. The example method can include selecting, by the one or more computing devices based on one or more results of the testing, a compilation strategy for at least one workload cluster associated with the at least one representative benchmark.

The example method can include obtaining, by the one or more computing devices, a second computational workload. The example method can include evaluating, by the one or more computing devices, the second computational workload to generate a second workload profile. The example method can include determining, by the one or more computing devices based on the second workload profile and the plurality of workload clusters, a workload cluster associated with the second computational workload. The example method can include outputting, based on the workload cluster associated with the second computational workload, one or more recommendations for improving a performance of the second computational workload.

In the example method, clustering the plurality of respective hardware usage profiles can include performing, by the one or more computing devices, a first clustering action to generate a first plurality of workload clusters. In the example method, clustering the plurality of respective hardware usage profiles can include performing, by the one or more computing devices based at least in part on the first plurality of workload clusters, a second clustering action to generate a second plurality of clusters.

In the example method, each respective hardware usage profile can include at least one of a floating-point operations usage, a memory bandwidth usage, and a communication bandwidth usage associated with communication between two or more processor devices.

Example aspects of the present disclosure provide one or more example non-transitory computer-readable media storing instructions that are executable by one or more processors to cause a computing system to perform example operations. In some implementations, the example operations can include evaluating a plurality of respective computational workloads to generate a plurality of respective hardware usage profiles. The example operations can include clustering the plurality of respective hardware usage profiles to generate a plurality of workload clusters. The example operations can include determining, based at least in part on the plurality of workload clusters, an allocation of computational hardware resources.

Example aspects of the present disclosure provide an example computing system that includes one or more processors and one or more example non-transitory computer-readable media storing instructions that are executable by one or more processors to cause a computing system to perform example operations. In some implementations, the example operations can include evaluating a plurality of respective computational workloads to generate a plurality of respective hardware usage profiles. The example operations can include clustering the plurality of respective hardware usage profiles to generate a plurality of workload clusters. The example operations can include determining, based at least in part on the plurality of workload clusters, an allocation of computational hardware resources.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system according to example implementations of aspects of the present disclosure.

FIG. 2 is a block diagram of an example system according to example implementations of aspects of the present disclosure.

FIG. 3 illustrates an example user interface according to example implementations of aspects of the present disclosure.

FIG. 4 is a flowchart diagram of an example method according to example implementations of aspects of the present disclosure.

FIG. 5 is a block diagram of an example networked computing system according to example implementations of aspects of the present disclosure;

FIG. 6 is a block diagram of an example computing device according to example implementations of aspects of the present disclosure; and

FIG. 7 is a block diagram of an example computing device according to example implementations of aspects of the present disclosure.

### DETAILED DESCRIPTION

Generally, the present disclosure is directed to systems and methods for efficiently allocating computational hardware resources based on clusters of computational workloads. For example, a plurality of computational workloads can be evaluated to generate a plurality of hardware usage profiles comprising hardware usage data associated with a respective computational workload. The plurality of hardware usage profiles can be clustered to generate a plurality of computational workload clusters. The workload clusters can be used to determine efficient allocations of hardware resources.

Generating a hardware usage profile can include, for example, simulating or executing a computational workload and tracking hardware usage during execution or simulation. For example, a workload can be executed for a fixed period of time, or a fixed-size workload can be executed until completion. During an execution or simulation period, a computing system can track a quantity of hardware operations performed (e.g., floating-point operations, bytes of memory transfer, etc.) or a time spent performing one or more hardware operations (e.g., time spent waiting for a communication operation to complete, etc.). A plurality of tracked quantities can be combined to form a hardware usage profile indicative of the hardware resources required to run the computational workload.

A plurality of hardware usage profiles can be clustered (e.g., via k-means clustering, etc.) to generate a plurality of computational workload clusters characterized by computational workloads having similar hardware usage profiles throughout each cluster. The computational workload clusters can then be used in a variety of ways to more efficiently allocate hardware resources for executing the plurality of computational workloads.

A computing system can determine an allocation of computational hardware resources based at least in part on the workload clusters. In some instances, an allocation of hardware resources can include a hardware device allocation mapping a plurality of computational workloads (e.g., currently pending workloads, scheduled or anticipated future workloads, etc.) to a plurality of hardware devices for executing the computational workloads. In some instances, an allocation of hardware resources can include a compilation strategy for compiling a computational workload, which can determine or influence how a computational workload is executed by hardware. As a non-limiting illustrative example, a “re-materialization” compiler option (e.g., aggressive re-materialization, no re-materialization, etc.) can determine whether executing a workload includes recomputing one or more already-computed floating-point values (e.g., using a processor device) or instead includes saving the already-computed values to memory and retrieving them from memory later (e.g., using a memory device).

In some instances, a hardware resource allocation according to the present disclosure can be automatically implemented by a computing device. For example, in some instances, a computing device can automatically select a compilation strategy based at least in part on cluster data and can automatically compile an uncompiled workload according to the compilation strategy. In some instances, a computing device can automatically select a workload-to-hardware-device mapping based at least in part on workload cluster data, and the computing device can automatically route one or more workloads to one or more hardware devices according to the mapping.

In some instances, a hardware resource allocation (e.g., compilation strategy, workload-to-hardware-device mapping, etc.) can be output (e.g., to a user). In some instances, additional information can be output, such as recommendations to revise a computational workload (e.g., by refactoring code, revising a model architecture, etc.) for improved performance.

In some example implementations, mapping a plurality of computational workloads to a plurality of hardware devices (e.g., processor devices, machine learning accelerators, etc.) can include using test data associated with one or more workload clusters. For example, in some instances, one or more workloads (e.g., representative benchmark workloads, etc.) associated with each cluster can be tested or simulated on a plurality of hardware device types. In some instances, a relative benefit (e.g., improved speed, reduced cost, reduced power usage, etc.) of running on a preferred hardware type can be determined based at least in part on cluster data. In some instances, a plurality of hardware devices can be assigned to a plurality of workloads based on comparative advantage, wherein a superior (e.g., lower-cost, more powerful, etc.) hardware device can be assigned to a workload that would benefit the most from being assigned to the superior device. In some instances, data indicative of a fleet of available hardware platforms can be compared to data indicative of a plurality of workloads, and the workloads can be mapped to the hardware platforms according to a fleetwide optimization strategy (e.g., heuristic optimization, machine-learned optimization, etc.).

In some example implementations, determining a compilation strategy for compiling a computational workload can be based on test data or other computational performance data associated with a workload cluster. For example, a plurality of compilation options can be tested on a representative benchmark or other workloads associated with a workload cluster, and compilation options can be selected based at least in part on test data associated with the compilation options.

An example field of application for the present disclosure can include allocating hardware resources for a plurality of machine learning workloads (e.g., training workloads, inference workloads, etc.). In some instances, example hardware devices can include machine learning accelerator devices (e.g., GPUs, TPUs, etc.) and machine learning accelerator platforms comprising one or more machine learning accelerator devices and one or more additional hardware devices for supporting the machine learning accelerator devices. Example compilers can include compilers for converting instructions from a high-level machine-learning framework (e.g., TensorFlow, PyTorch, etc.) to low-level instructions for execution by one or more hardware components. However, systems and methods of the present disclosure are not limited to any particular use case, and provided systems and methods can be used for other types of computational workloads without going outside the scope of the present disclosure.

Systems and methods according to examples of the present disclosure provide a variety of technical effects and benefits. In some instances, example systems and methods can provide improved performance (e.g., faster computation, reduced power usage, etc.) for an individual workload running on a given hardware device. For example, example systems and methods can determine and execute compilation strategies that can provide improved performance compared to alternative compilation strategies. Additionally, example systems and methods can automatically route a computational workload to a hardware device that can execute that workload with improved performance compared to alternative workload routing strategies. In some instances, example systems and methods can provide improved collective performance or fleet-level performance (e.g., reduced hardware usage, reduced power usage, higher computational throughput, etc.) for a plurality of workloads running on a plurality of hardware devices. For example, example systems and methods can provide multi-device (e.g., fleetwide) hardware device scheduling that can assign a hardware device to a computational workload associated with the largest relative benefit of using the hardware device, thereby improving a total computational benefit (e.g., reduced total computational cost, etc.) of operating a plurality (e.g., thousands) of computational workloads on a plurality (e.g., fleet) of hardware devices. In some instances, example systems and methods can reduce a cost (e.g., power cost, hardware usage, financial cost, etc.) associated with executing one or more computational workloads. For example, systems and methods according to examples of the present disclosure can automatically determine and execute reduced-cost (e.g., reduced-power-usage, etc.) compilation strategies and reduced-cost workload-to-hardware mappings.

In another example aspect, example implementations can provide for more energy-efficient computations (e.g., machine learning training operations or model updates). In this manner, for instance, the improved energy efficiency of example implementations of the present disclosure can reduce an amount of pollution or other waste associated with implementing computational workloads, thereby advancing the field of computation as a whole. The amount of pollution can be reduced in toto (e.g., an absolute magnitude thereof) or on a normalized basis (e.g., energy per task, per machine-learned model size, etc.). For example, an amount of CO2 released (e.g., by a power source) in association with a computational workload can be reduced by implementing more energy-efficient operations. An amount of heat pollution in an environment (e.g., by the processors/storage locations) can be reduced by implementing more energy-efficient operations.

Various example implementations are described herein with respect to the accompanying Figures.

### Example Systems

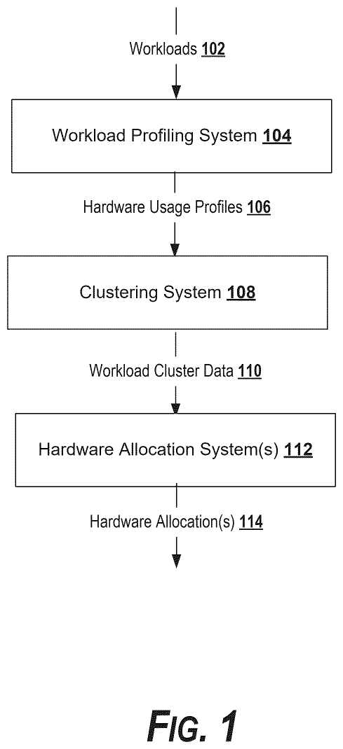

FIG. 1 is a block diagram of an example system according to example implementations of aspects of the present disclosure. A workload profiling system 104 can analyze a plurality of workloads 102 to generate a plurality of hardware usage profiles 106. A clustering system 108 can cluster the plurality of hardware usage profiles 106 to generate workload cluster data 110. One or more hardware allocation systems 112 can determine one or more hardware allocations 114 based at least in part on the workload cluster data 110.

Computational workloads 102 can include, for example, any tasks to be performed by one or more computational hardware devices. For example, computational workloads 102 can include machine-readable instructions that, when executed, cause one or more computational hardware devices to perform one or more operations. Computational workloads 102 can include, for example, one or more tasks defined by software (e.g., application software, operating system software, etc.), firmware (e.g., bios, etc.), computer code (e.g., source code, object code, etc.), or other machine-readable instructions. In some instances, computational workloads 102 can include one or more machine learning tasks (e.g., training, inference, etc.). In some instances, a machine learning task can include a plurality of matrix multiplications in combination with a plurality of additional tasks (e.g., activation functions, summations, etc.) In some instances, a machine learning task can include a plurality of tasks to initialize or otherwise support matrix multiplications (e.g., communication between processors, loading numerical values into processor memory, etc.). In some instances, a computational workload 102 (e.g., machine learning workload) can include a plurality of task types to be performed by a plurality of different hardware device types (e.g., memory device, processor device, etc.). In some instances, a computational workload 102 can include an uncompiled workload or compiled workload. In some instances, an uncompiled workload can comprise a plurality of high-level instructions (e.g., source code, etc.) capable of being performed in more than one way (e.g., using different combinations of hardware-specific tasks). In some instances, a compiled workload can include a plurality of low-level instructions (e.g., compiled binary code, assembly code, machine code, etc.) configured to be performed only one way (e.g., using a particular combination of hardware-specific tasks). In some instances, a computational workload 102 can include one or more hyperparameters, such as a minimum required or preferred performance (e.g., maximum time to completion, minimum FLOPS, etc.); a minimum required or preferred number of processor devices to be used (sometimes referred to as “slice size”) in executing the computational workload 102; a length of time to execute the computational workload 102 (e.g., 30 seconds, one minute, 10 minutes, etc.) when generating a hardware usage profile 106; or other execution parameter.

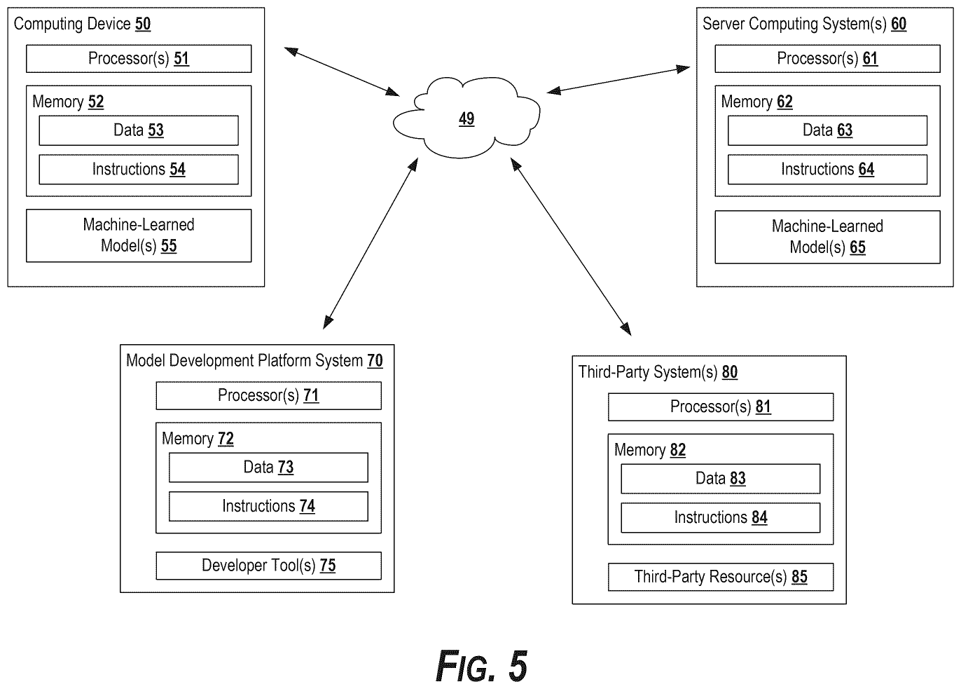

The workload profiling system 104 can be or include one or more software, firmware, or hardware components configured to process workloads 102 and generate hardware usage profiles 106. The workload profiling system 104 can include one computing device or multiple computing devices. In some instances, the workload profiling system 104 can be, include, implement, or be implemented by a computing device described below with respect to FIGS. 5-7 (e.g., server computing system 60, etc.).

A hardware usage profile 106 can include data (e.g., numerical data, binary data, etc.) indicative of hardware usage associated with a particular workload 102. For example, a hardware usage profile 106 can indicate a number of floating-point operations performed by one or more processor devices (e.g., CPU, TPU, GPU, etc.) when executing the workload 102 (e.g., for a fixed period of time; for a fixed task size; etc.). Similarly, a hardware usage profile 106 can include data indicating usage amounts for a plurality of other resources, such as high-bandwidth memory (HBM), vector processing units (VPU), datacenter network over ethernet (DCN), inter-chip interconnect (ICI), random access memory (e.g., SRAM, etc.), in-feed (input) communications, matrix units (MXUs), embedding processor units, etc. A usage amount can include, for example, a number of bytes (e.g., gigabytes, etc.) accessed or communicated; a number of operations performed; a number of values (e.g., floating-point numbers, etc.) processed by the hardware; etc.

A hardware usage profile 106 can also include, for example, data indicative of time spent using one or more hardware devices. In some instances, hardware usage profile 106 can include data indicative of one or more bottlenecks, wait times, or critical path sensitivities. For example, a hardware usage profile 106 can include data indicative of time spent performing a plurality of hardware operations (e.g., ICI communication, HBM access, MXU FLOPs, etc.), including time spent performing only one type of hardware operation (e.g., only FLOPs, only HBM access, etc.) or using only one type of hardware device (e.g., HBM, plurality of MXUs, etc.), wherein hardware devices of other types may remain idle while waiting for a plurality of operations to complete. In some instances, a hardware usage profile 106 can include critical path data indicative of an amount of time (e.g., percentage, number of milliseconds, etc.) spent performing each of a plurality of hardware operations. In some instances, critical path data can include an amount of overlap between two or more hardware operations. As a non-limiting illustrative example, critical path data may indicate that a computing device executing a workload 102 spent 80 percent of a total execution time performing floating-point operations, 80 percent of the total execution time performing high-bandwidth memory operations, with 70 percent of the total execution time performing both high-bandwidth memory operations and floating-point operations simultaneously.

In some instances, a hardware usage profile 106 can include one or more derived data values (e.g., statistics determined based on one or more observed or collected data values, etc.). In some instances, a derived data value can include a utilization percentage, such as a ratio between a hardware usage amount and a maximum hardware usage amount (e.g., FLOPS used divided by maximum available FLOPS, etc.). In some instances, a derived data value may be determined based on a combination of more than one type of hardware operation. For example, in some instances, a hardware usage profile 106 can include one or more operational intensity values, which can be a ratio between a first hardware usage amount (e.g., floating-point operations performed) and a second hardware usage amount (e.g., gigabytes (GB) of HBM bandwidth used, GB of ICI or DCN communication, number of convolution fusion operations, etc.). A first and second hardware usage amount can include a number of hardware operations performed of a particular operation type or a usage amount associated with a particular hardware device type. In some instances, a hardware usage profile 106 can include a sum of a plurality of hardware usage values. As a non-limiting illustrative example, inter-chip communication time can include a sum of usage amounts for a plurality of inter-chip communication operation types (e.g., ICI, DCN, etc.; all-to-all, all-reduce, etc.).

In some instances, a hardware usage profile 106 can include power data associated with one or more hardware operations. In some instances, the power data can include power provisioning data indicative of an amount of power requested or reserved by a computing system when performing a particular computational workload 102. In some instances, the power data can include power usage data indicative of an amount of power actually used (e.g., on average; in a worst case; etc.) by a computing system to execute a computational workload 102. In some instances, the power data can include power data associated with particular hardware operations (e.g., floating-point operations, HBM access, etc.) or groups of hardware operations performed when executing the workload 102. In some instances, the power data can include power data associated with the computational workload 102 as a whole.

In some instances, generating a hardware usage profile 106 for a computational workload 102 can include executing the workload 102 using one or more hardware devices and tracking usage of the one or more hardware devices during execution. For example, in some instances, the workload profiling system 104 can use one or more performance counters (e.g., hardware performance counters, hypervisors, etc.) to track a usage amount of one or more hardware devices. Hardware performance counters can include, for example, special-purpose hardware registers configured to store counts associated with one or more hardware-related activities (e.g., number of floating-point operations performed by one or more processor devices, number of clock cycles spent performing floating-point operations, etc.). In some instances, generating a hardware usage profile 106 can include one or more software-based hardware tracking functions (e.g., code instrumentation, etc.) for tracking a usage amount associated with one or more hardware-related activities (e.g., time spent performing floating-point operations, time spent performing inter-chip communication, etc.). For example, in some instances, a first timestamp can be recorded immediately before one or more hardware operations are performed (e.g., inter-chip communications, etc.); a second timestamp can be recorded immediately after one or more hardware operations are performed; and a hardware usage time can be determined based on a comparison between the first timestamp and second timestamp.

In some instances, the workload profiling system 104 can generate a hardware usage profile 106 by simulating execution of the workload 102. For example, in some instances, a workload simulator can generate a graph of a plurality of high-level operations (e.g., matrix multiplications, etc.) expected to be performed during execution of the workload 102. In some instances, a graph of high-level operations can be correlated with a plurality of low-level hardware operations to generate a hardware usage profile 106. As a non-limiting illustrative example, a workload simulator can analyze high-level machine learning code (e.g., TensorFlow code, etc.) defining a machine-learning model architecture (e.g., neural network with a particular number of layers, parameters per layer, etc.) and a plurality of operations (e.g., matrix multiplications using matrices of a particular size, etc.) to be performed during a forward pass associated with the machine-learning model architecture, and can generate a data structure (e.g., graph, list, etc.) indicative of a number of high-level operations to be performed. The workload profiling system 104 can access a data structure correlating one or more high-level operations (e.g., matrix multiplications, etc.) with one or more low-level operations required to perform the high-level operations on a particular hardware platform (e.g., load matrix values into processor memory; perform multiplications; perform inter-chip communication such as all-to-all or all-reduce; etc.). Based on the data structure indicative of the high-level operations and the data structure correlating the high-level operations with low-level operations, the workload profiling system 104 can generate a hardware usage profile 106 for the workload 102.

In some instances, a hardware usage profile 106 can include data associated with a plurality of hardware types, workload executions, or workload simulations. For example, in some instances, a workload can be executed on a plurality of respective hardware platforms (e.g., as part of a hardware architecture sensitivity sweep, etc.) and a hardware usage profile 106 can comprise one or more respective datapoints from each respective execution. As another example, a workload profiling system 104 can access a data structure correlating high-level operations to a plurality of possible low-level execution strategies, and a plurality of possible low-level hardware usage amounts can be determined for performing a workload's high-level operations.

The clustering system 108 can be or include one or more software, firmware, or hardware components configured to process hardware usage profiles 106 and generate workload cluster data 110. The clustering system 108 can include one computing device or multiple computing devices. The clustering system 108 can be the same as, different from, or share one or more components with a workload profiling system 104. In some instances, the clustering system 108 can be, include, implement, or be implemented by a computing device described below with respect to FIGS. 5-7 (e.g., server computing system 60, etc.).

Workload cluster data 110 can include, for example, data indicative of a plurality of workload clusters (e.g., cluster names, cluster centroids, workloads 102 associated with each cluster, etc.). Workload cluster data 110 can include, for example, data indicative of a plurality of cluster labels or cluster assignments. For example, each workload 102 can in some instances be associated with a particular clusters. In such instances, workload cluster data 110 can include data indicating, for each workload 102, which cluster or clusters the workload 102 may belong to. In some instances, workload cluster data 110 can include additional data associated with each cluster, such as statistical, numerical, or other data. For example, workload cluster data 110 can include statistical data, such as data indicative of a plurality of means or standard deviations associated with a plurality of hardware usage profile 106 features; data indicative of one or more coefficients of variation associated with the cluster; etc.

In some instances, clustering the hardware usage profiles 106 can include determining one or more hardware usage features based on hardware usage data of the hardware usage profiles 106. For example, in some instances, a hardware usage feature can include hardware usage associated with a plurality of operations (e.g., related operations, etc.). As a non-limiting illustrative example, data indicative of inter-chip communication operations (sometimes referred to as “collective operations”) such as all-to-all, all-reduce, etc., can be grouped together to form a hardware usage feature associated with collective operations. In some instances, one or more categories of hardware usage profile 106 data can be used as hardware usage features without modification (e.g., convolution fusion operations, infeed operations, output fusion operations, etc.). In some instances, hardware usage features can include ratios (e.g. operational intensity, etc.) or other combinations of two or more hardware usage profile 106 datapoints. In some instances, feature data for clustering workloads 102 can include other workload data, such as a scale of the workload or a number of processors (“slice size”) used to execute the workload 102.

In some instances, clustering the hardware usage profiles 106 can include clustering a plurality of hardware usage features (e.g., using k-means clustering, g-means clustering, density-based clustering, graph-based clustering, neural clustering, etc.). In some instances, a number of clusters to generate can be selected based on one or more statistical measures associated with the clusters (e.g., variance, coefficient of variation, etc.). For example, a first number of clusters can be generated (e.g., using k-means clustering), and a coefficient of variation (e.g., ratio of standard deviation to mean, etc.) can be determined for each cluster. In some instances, an average coefficient of variation can be compared to a variation threshold, and the first number of clusters can be retained if the coefficient of variation is below the threshold. In some instances, a second number (e.g., larger than the first number) of clusters can be generated (e.g., using k-means clustering), and a coefficient of variation can be determined for each cluster of the second plurality of clusters. An average reduction in variation can be determined by comparing the coefficients of variation of the second plurality of clusters to the coefficients of variation of the first plurality of clusters. A reduction in variation can be compared to a reduction threshold, and the second number of clusters can be retained if the reduction in variation is below the threshold. Additional (third, fourth, etc.) numbers of clusters can be generated until a statistical measure (e.g., reduction in variation, etc.) is below a threshold (e.g., predefined threshold; relative threshold based on prior reduction values or variation values; etc.). Different statistical measures (e.g., ratios of within-cluster variance to between-cluster variance; ratios of between-cluster variance to total variance; etc.) can be used instead of or in addition to coefficients of variation. In some instances, selecting a number of clusters can include analyzing (e.g., using automated analysis, human analysis, etc.) the clusters to verify that the workloads 102 of each cluster share one or more relevant hardware usage properties. Similarly, in some instances, a number of hardware usage features to use when determining the clusters can be selected based on one or more statistical measures associated with the clusters or one or more analyses of the clusters (e.g., according to methods described above for selecting a number of clusters).

The hardware allocation system(s) 112 can be or include one or more software, firmware, or hardware components configured to process workload cluster data 110 and generate hardware allocation(s) 114. The hardware allocation system(s) 112 can include one computing device or multiple computing devices. The hardware allocation system(s) 112 can be the same as, different from, or share one or more components with a workload profiling system 104 or clustering system 108. In some instances, the hardware allocation system(s) 112 can be, include, implement, or be implemented by a computing device described below with respect to FIGS. 5-7 (e.g., server computing system 60, etc.).

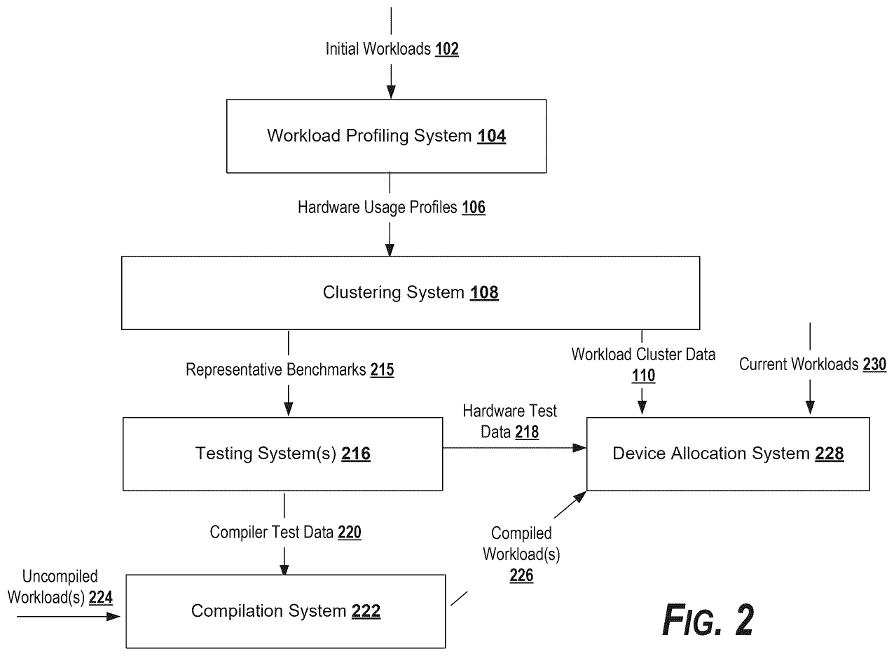

Hardware allocation(s) 114 can include, for example, any mapping of one or more computational operations to one or more hardware operations. A computational operation can include, for example, a workload 102 or one or more subcomponents of a workload 102. In some instances, a computational operation can include a high-level operation (e.g., matrix multiplication, etc.) defined in source code (e.g., PyTorch, TensorFlow, etc.). A hardware allocation 114 can include, for example, a compilation strategy for mapping (e.g., using a compiler) one or more computational operations (e.g., high-level operations defined in source code) to one or more hardware operations. In some instances, a hardware allocation 114 can include a mapping of one or more workloads 102 or workload subcomponents to one or more hardware devices (e.g., GPUS or TPUs; computing systems; etc.) for executing the workloads 102 or subcomponents. In some instances, a hardware allocation 114 can include a scheduling of one or more workloads 102, which can include a particular time to execute the workloads 102. In some instances, a hardware allocation 114 can include a refactoring plan for modifying source code to perform a similar (e.g., same) operation or achieve a similar (e.g., same) outcome using different operations (e.g., different high-level computational operations defined by source code, different hardware operations, etc.). Additional example implementation details for implementing hardware allocations 114 are further provided below with respect to FIG. 2.

FIG. 2 is a block diagram of an example system according to example implementations of aspects of the present disclosure. A workload profiling system 104 can analyze a plurality of initial workloads 102 to generate a plurality of hardware usage profiles 106. A clustering system 108 can cluster the plurality of hardware usage profiles to generate workload cluster data 110. The clustering system 108 can generate a plurality of representative benchmarks 215 associated with a plurality of workload clusters, and a testing system 216 can test the representative benchmarks 215 to generate hardware test data 218 and compiler test data 220. Based on the compiler test data 220, a compilation system 222 can determine one or more compilation strategies, and can automatically compile uncompiled workloads 224 into compiled workloads 226 according to the compilation strategies. Based on the hardware test data 218 and workload cluster data 110, a device allocation system 228 can determine a hardware assignment mapping a plurality of current workloads 230 to a plurality of hardware devices. In some instances, the device allocation system 228 can automatically route the current workloads 230 to a plurality of hardware devices according to the hardware assignment.

A representative benchmark 215 can be, for example, a workload 102 configured to be used as a benchmark associated with a particular workload cluster. In some instances, a representative benchmark 215 can be selected from a plurality (e.g., cluster) of initial workloads 102. In some instances, selecting a representative benchmark 215 can include determining a distance between one or more initial workloads 102 and a cluster centroid associated with a workload cluster. In some instances, an initial workload 102 that is closest to the cluster centroid can be selected as a representative benchmark 215. In some instances, a representative benchmark 215 can be selected based on one or more other factors, instead of or in addition to a distance from a cluster centroid. For example, some initial workloads 102 may involve confidential data or may otherwise be unsuitable for certain testing processes (e.g., providing the benchmarks to third-party testers such as hardware manufacturers, etc.). In such instances, a closest suitable initial workload 102 can be selected as a representative benchmark 215. In some instances, a representative benchmark 215 can be generated (e.g., based on one or more initial workloads 102) rather than selected. For example, in some instances, a non-confidential synthetic workload may be generated such that the synthetic workload is at or near a cluster centroid associated with a cluster. In some instances, for example, confidential operations of one or more initial workloads 102 can be masked using non-confidential operations having similar (e.g., same) hardware usage properties. In some instances, a plurality of initial workloads 102 or workload subcomponents can be combined to generate a workload that may be nearer to a cluster centroid than any existing initial workload 102.

The testing system(s) 216 can be or include one or more software, firmware, or hardware components configured to process workloads 102, 224, 226, 230 (e.g., representative benchmarks 215) and generate test data 218, 220. The testing system(s) 216 can include one computing device or multiple computing devices. The testing system(s) 216 can be the same as, different from, or share one or more components with a workload profiling system 104, clustering system 108, or hardware allocation system(s) 112. In some instances, the testing system(s) 216 can be, include, implement, or be implemented by a computing device described below with respect to FIGS. 5-7 (e.g., server computing system 60, etc.).

In some instances, the testing system 216 can generate hardware test data 218 by executing one or more representative benchmarks 215 or other computational workloads 102, 224, 226, 230 on one or more hardware devices (e.g., computing systems, machine learning accelerator platforms, machine learning accelerator chips, etc.). In some instances, generating hardware test data 218 can include generating hardware usage profile 106 data according to one or more example methods described above with respect to FIG. 1. In some instances, generating hardware test data 218 can include executing a workload and measuring an overall performance (e.g., power usage, speed, total cost to execute, etc.) associated with executing the workload.

Hardware test data 218 can include, for example, data indicative of one or more test results associated with one or more representative benchmarks 215 or other computational workloads 102, 224, 226, 230 and one or more hardware devices. In some instances, hardware test data 218 can include hardware usage profile 106 data according to examples described above with respect to FIG. 1. In some instances, hardware test data can include one or more performance metrics associated with executing a workload on a hardware device. Example performance metrics can include, for example, an amount of power used to execute a computational workload; an execution time or execution speed associated with a computational workload; a number of operations performed per second (e.g., FLOPS, etc.); a number of hardware devices required to achieve a threshold number of operations per second (e.g., machine learning queries per second, etc.); a total cost to execute a computational workload; etc. In some instances, example performance metrics can include a ratio between two or more other performance metrics (e.g., ratio of execution speed to power usage; computational throughput to cost of operation; computational throughput on first hardware device to computational throughput on second hardware device; etc.). In some instances, example performance metrics can include a relative performance improvement (e.g., percentage execution time speedup, etc.) associated with executing on a first hardware device (e.g., TPU V4), as compared to a second hardware device (e.g., TPU V3, etc.). In some instances, an example performance metric can include a ratio of one or more hardware usage profile 106 datapoints to one or more roofline parameters (e.g., maximum FLOPS, maximum HBM bandwidth, etc.) associated with a hardware device. In some instances, an example roofline metric can include max (FLOPS-utilization, HBM-utilization) where FLOPS-utilization can be a ratio between FLOPS used in executing a computational workload and maximum FLOPs a hardware device is capable of performing. In other words, FLOPS- or HBM-utilization can be a ratio between a hardware usage demand associated with a computational workload and a hardware usage availability supplied by one or more hardware devices on which the computational workload is executed.

In some instances, generating hardware test data 218 can include performing one or more sensitivity sweeps (e.g., hardware architecture sensitivity sweeps, parameter sensitivity sweeps, etc.). For example, in some instances, a representative benchmark 215 can be parameterized and the representative benchmark 215 can be tested using a plurality of parameter values. Parameterizing a representative benchmark 215 can include, for example, adjusting a number or type of computational operations to be performed (e.g., size of a matrix multiplication, architecture of a machine-learning model, slice size for executing a computational workload, etc.) based on one or more input parameters. In some instances, a scale of a computational workload (e.g., number of high-level operations, scale of each high-level operation such as matrix multiplication size, etc.) can be parameterized based on a scale parameter. In some instances, a computational workload can be parameterized based on one or more hyperparameters for compiling or executing a computational workload (e.g., number of processors to be used in parallel for executing the computational workload, compilation strategy for compiling the computational workload, etc.). In such instances, a plurality of tests can be run based on a plurality of parameters or hyperparameters to generate a plurality of performance metrics associated with a computational workload (e.g., representative benchmark 215, etc.). In such instances, the plurality of performance metrics can be compared to determine a computational workload's (e.g., representative benchmark 215's) sensitivity to one or more parameters. In some instances, a parameter sensitivity sweep can be performed using a plurality of workloads (e.g., current workloads 230 of a particular cluster, proxy or benchmark workloads, etc.) having a plurality of different characteristics (e.g., scale, slice size, machine-learning model architecture, etc.), instead of or in addition to a parameterized benchmark.

In some instances, generating hardware test data 218 can include performing one or more architecture sensitivity sweeps. For example, a plurality of hardware architectures (e.g., related hardware architectures) can be tested using similar (e.g., same) workloads (e.g., representative benchmarks 215, etc.). For example, a particular representative benchmark 215 can be tested on a plurality of different hardware architectures comprising different hardware capacities (e.g., different numbers of MXUs, arithmetic logic units, etc.; different HBM bandwidths, maximum FLOPs, etc.). In some instances, one or more first hardware architecture features can remain fixed, while one or more second hardware architecture features can be modified to test a sensitivity of a particular workload's performance (e.g., execution speed, execution time, power usage, operational cost, FLOPS, etc.) to changes to the second hardware architecture features. Hardware architecture sensitivity sweep data can include, for example, any comparison or combination (e.g., ratio, difference, etc.) of hardware test data 218 associated with two or more hardware configurations.

Compiler test data 220 can include, for example, data indicative of one or more test results associated with one or more representative benchmarks 215 or other computational workloads 102, 224, 226, 230 and one or more compilation strategies. For example, a testing system 216 can compile a computational workload (e.g., representative benchmark 215) according to a first compilation strategy and execute the compiled workload 226 on one or more hardware devices. The testing system 216 can collect compiler test data 220 indicative of a performance of the compiled workload 226. The compiler test data 220 can include, for example, any data category (e.g., performance metrics, ratios, hardware usage profile 106 data, etc.) described above with respect to hardware test data 218. The compiler test data 220 can also include, for example, data indicative of one or more compilation strategies used in performing a particular test. In some instances, the testing system 216 can compile the computational workload according to a second compilation strategy, execute the second compiled workload, and collect compiler test data 220 associated with the second compilation strategy. Additional (third, fourth, etc.) compilation strategies can also be tested. In this manner, for instance, a plurality of compilation strategies can be compared, and one or more preferred compilation strategies (e.g., fastest-execution-time compilation strategy, lowest-power-usage compilation strategy, etc.) can be selected. In some instances, generating compiler test data 220 can include performing one or more sensitivity sweeps as described above with respect to hardware test data 218.

In some instances, compiler test data 220 can be collected from sources other than a testing system 216. For example, in some instances, a plurality of compiled workloads 226 (e.g., associated with an enterprise machine learning fleet, etc.) may be executed by a plurality of computing devices (e.g., devices hosted by a computing provider). In such instances, performance data associated with the compiled workloads 226 can be collected. In some instances, one or more of uncompiled workloads 224 associated with one or more existing compiled workloads 226 may be occasionally recompiled (e.g., at the direction of a user, etc.) to generate a new compiled workload 226. In such instances, compiler test data 220 associated with the new compiled workload 226 can be compared to compiler test data 220 associated with the existing compiled workload 226 to determine whether a compilation strategy used to compile the new compiled workload 226 is preferable to a compilation strategy used to compile the existing compiled workload 226. In instances where one compilation strategy (e.g., compiler option or combination of compiler options, etc.) is found to be preferable, the compilation strategy can be used to compile future uncompiled workloads 224 that share a workload cluster with the new and existing compiled workloads 226. For example, an advantageous compiler option can be added to a list of compiler options to be used when compiling workloads of a particular cluster.

The compilation system 222 can be, for example, a hardware allocation system 112. The compilation system 222 can be or include one or more software, firmware, or hardware components configured to process uncompiled workloads 224 and generate compiled workloads 226.

An uncompiled workload 224 can include, for example, a computational workload (e.g., plurality of high-level computational tasks) that has not been compiled into a fixed set of hardware tasks. In some instances, an uncompiled workload 224 can include source code (e.g., TensorFlow or PyTorch source code, etc.) describing a plurality of computational operations (e.g., high-level machine-learning operations, etc.) that can be performed by hardware in a plurality of different ways (i.e. using a plurality of different combinations of low-level hardware operations or hardware devices). An uncompiled workload 224 can be, comprise, be comprised by, or otherwise share one or more properties with a workload 102.

A compiled workload 226 can include, for example, a plurality of machine-readable instructions that, when executed, will cause one or more hardware devices to perform one or more hardware operations. In some instances, the hardware operations can include a predefined or fixed set of hardware operations to be performed in exactly one way. In some instances, a compiled workload 226 can include binary object code (e.g., machine code, etc.) compiled from an uncompiled workload 224 (e.g., source code, etc.) using a compiler.

In some instances, an uncompiled workload 224 or compiled workload 226 can be assigned to one or more clusters. For example, in some instances, an uncompiled workload 224 or one or more subcomponents of the uncompiled workload 224 can be compiled into a compiled workload 226 (e.g., according to an arbitrary or default compilation strategy, etc.). The compiled workload 226 or one or more subcomponents of a compiled workload 226 can be executed (e.g., for a specific period of time, until completion, etc.). Hardware usage profile 106 data can be generated for the compiled workload 226. In some instances, hardware usage feature data can be determined based on the hardware usage profile 106 data. A distance metric (e.g., Euclidean distance, Manhattan distance, cosine distance, etc.) can be computed between the hardware usage profile 106 data or hardware feature data of the compiled workload 226 and each centroid of a plurality of clusters. Based on the distance metrics, a compiled workload 226 can be assigned to one or more (e.g., one, two, etc.) nearest clusters. In some instances, an uncompiled workload 224 can be assigned to the same cluster or clusters as a compiled workload 226 generated from the uncompiled workload 224.

In some instances, the compilation system 222 can select a compilation strategy to compile an uncompiled workload 224 to generate a compiled workload 226. In some instances, a compilation strategy can include a choice of one or more compiler options associated with a particular compiler; a choice of a particular compiler to use; etc. In some instances, a preferred compilation strategy for a particular uncompiled workload 224 can be selected based on compiler test data 220 generated from one or more workloads (e.g., representative benchmarks 215, compiled workloads 226) associated with a same cluster as the uncompiled workload 224. In some instances, selecting a compilation strategy can be based at least in part on one or more properties (e.g., manufacturer, hardware capacity data, etc.) of a hardware device on which an uncompiled workload 224 is expected to be executed. In some instances, selecting a compilation strategy can be based at least in part on individual properties of an uncompiled workload 224 (e.g., scale, slice size, etc.) that may be different from a workload of the same cluster for which compiler test data 220 is available. For example, in some instances, compiler test data 220 may include sensitivity sweep data associated with one or more workload parameters (e.g., scale, slice size, percentage of time spent in convolution operations, etc.), and a compilation strategy can be selected based at least in part on the sensitivity sweep data. For example, in some instances, one or more compiler strategy thresholds (e.g., scale threshold, slice size threshold) for a cluster can be determined based on sensitivity sweep data for the cluster, and a compiler strategy can be selected based on a comparison between a compiler strategy threshold and a workload parameter of an uncompiled workload 224.

The device allocation system 228 can be, for example, a hardware allocation system 112. The compilation system 222 can be or include one or more software, firmware, or hardware components configured to assign a plurality of current workloads 230 to a plurality of hardware devices for executing the current workloads 230. In some instances, the device allocation system 228 can automatically route current workloads 230 to assigned hardware devices according to an allocation plan generated by the device allocation system 228. In some instances, the device allocation system 228 can output (e.g., to a user, to another computing device, etc.) a hardware allocation mapping a plurality of current workloads 230 to a plurality of hardware devices.

A current workload 230 can be, comprise, be comprised by, or otherwise share one or more properties with a workload 102. A plurality of current workloads 230 can be, for example, a plurality of workloads to be scheduled for execution (e.g., immediate execution, future execution, etc.) by one or more hardware devices (e.g., presently available hardware devices, presently busy hardware devices, powered-off or standby hardware devices, future hardware devices, etc.).

In some instances, a current workload 230 can be assigned to one or more clusters. For example, a current workload 230 or one or more subcomponents of a current workload 230 can be executed (e.g., for a specific period of time, until completion, etc.). Hardware usage profile 106 data can be generated for the a current workload 230. In some instances, hardware usage feature data can be determined based on the hardware usage profile 106 data. A distance metric (e.g., Euclidean distance, Manhattan distance, cosine distance, etc.) can be computed between the hardware usage profile 106 data or hardware feature data of the a current workload 230 and each centroid of a plurality of clusters. Based on the distance metrics, a current workload 230 can be assigned to one or more (e.g., one, two, etc.) nearest clusters.

Hardware devices to which the current workloads 230 can be assigned can include, for example, any computational hardware configured to execute all or part of a current workload 230. As non-limiting illustrative examples, hardware devices can include processor devices (e.g., TPUs, GPUs, MXUs, arithmetic logic units, CPUs, embedding processor devices, etc.), memory devices (e.g., HBM, SRAM, DRAM, etc.), communication devices or communication interfaces (e.g., ICI, DCN, etc.), application-specific integrated circuits (e.g., TPUs, GPUs, etc.), hardware platforms comprising a plurality of hardware devices (e.g., machine learning accelerator platforms comprising GPUs or TPUs and related hardware devices for operating the TPUs or GPUs, such as boards, memory, supplemental processor devices, interconnection hardware, etc.), computing devices or systems comprising a plurality of hardware devices, etc.

In some instances, a device allocation system 228 can generate a hardware allocation mapping a plurality of current workloads 230 to a plurality of hardware devices by obtaining a data structure (e.g., list, summary, etc.) indicative of the current workloads 230; obtaining a data structure (e.g., list, summary, etc.) indicative of a plurality of hardware devices available for executing the current workloads 230; and mapping the current workloads 230 to the hardware devices. In some instances, the data structure indicative of the plurality of hardware devices can include quantity data (e.g., number of devices or hardware platforms of a particular type), performance characteristic data (e.g., FLOPS; memory bandwidth data; vector performance data; memory capacity data; communication bandwidth data; etc.) and hardware architecture data (e.g., number and type of each device in a platform; topological information describing connections between hardware devices such as mesh, torus, or tree; etc.). In some instances, the data structure indicative of the plurality of workloads can include quantity data (e.g., number of workloads associated with each workload cluster), workload operational requirements or preferences associated with one or more individual workloads (e.g., number of queries that must be processed per minute, requester priority, geographic constraints, total cost, requester quota on a specific machine type, etc.), and other workload characteristic data (e.g., workload size or scale, parameters or hyperparameters, etc.). In some instances, the data structure indicative of the current workloads 230 can include cluster performance data, such as hardware test data 218, hardware usage profile data 206, or other performance data associated with workloads in each cluster. In some instances, mapping the current workloads 230 to the hardware devices can include one or more heuristic optimization strategies (e.g., genetic algorithm, simulated annealing, etc.) or one or more machine-learned optimization strategies.

In some instances, mapping the current workloads 230 to the hardware devices can be based at least in part on a comparative advantage (e.g., comparative cost reduction advantage, power usage reduction advantage, relative speed improvement advantage, etc.) associated with executing a current workload 230 on a first hardware device instead of a second hardware device. For example, if two current workloads 230 both would perform better on a first hardware device compared to a second hardware device, a device allocation system 228 can automatically determine which of the two current workloads 230 would see the greatest advantage (e.g., greatest reduction in power usage in kWh, etc.), and assign the first hardware device to the current workload 230 that would gain the most from being assigned to the first hardware device. In some instances, routing based on comparative advantage can include identifying a cluster with the largest comparative advantage compared to other clusters, and routing a plurality of workloads of that cluster to a preferred hardware device. In some instances, routing based on comparative advantage can be based at least in part on individual characteristics of individual workloads (e.g., workload size or scale, workload operational requirements, parameter sensitivity sweep data, etc.). In some instances, routing based on comparative advantage can be based at least in part on architectural sensitivity sweep data. In some instances, routing based on comparative advantage can include reserving (e.g., idling, placing on standby, etc.) one or more hardware devices for use by an anticipated future workload (e.g., reserving a preferred hardware device for use by a near-term scheduled workload with a greater comparative advantage than a current workload, etc.).

In some instances, a device allocation can include a mapping of anticipated future workloads to anticipated future hardware. For example, in some instances, a workload scheduler can obtain a data structure indicative of scheduled or estimated future workloads; obtain a data structure indicative of scheduled or estimated future hardware availability; and map the future workloads to the future hardware devices (e.g., via heuristic optimization, machine-learned optimization, etc.). In some instances, future workloads can include near-term future workloads (e.g., next few minutes, hours, days, etc.) or long-term future workloads (e.g., next few months, years, etc.). In some instances, estimated future workloads or estimated future hardware availability can include data indicative of a range of possible pluralities of future workloads or pluralities of future available devices (e.g., 95 percent confidence interval data, expected value and standard deviation data, etc.). In some instances, estimated future workloads can be determined based at least in part on scheduled future workloads or other future planning data. In some instances, estimated future workloads can be determined based at least in part on historical workload data (e.g., hourly workload data from past days, weeks, etc.; long-term historical workload data for a plurality of business units; etc.). In some instances, data indicative of anticipated future workloads can include anticipated cluster data or anticipated individual workload characteristic data for each of a plurality of anticipated future workloads.

In some instances, a mapping of anticipated future workloads to anticipated future hardware can be used when determining a mapping of current workloads to currently available hardware. For example, if a current workload 230 and a future workload would both perform better on a first hardware device compared to a second hardware device, a device allocation system 228 can determine whether to route the current workload 230 to the first hardware device or reserve the first hardware device for the future workload (e.g., based on a comparative advantage of the current workload 230 and the future workload; a scheduled execution time of the future workload; an expected runtime of the current workload 230; etc.). In some instances, a mapping of anticipated future workloads to anticipated future hardware can be used to select one or more characteristics of future hardware (e.g., quantity, architecture, etc.) to be made available (e.g., by activating one or more idle hardware devices; by accessing one or more existing hardware devices, such as via a cloud computing service; by manufacturing, purchasing, or otherwise acquiring new hardware devices; etc.). For example, a first subset of a plurality of anticipated future workloads can be mapped to a plurality of currently available hardware devices (e.g., based on cluster data, based on comparative advantage data, etc.); data associated with the a second subset of the plurality of anticipated future workloads (e.g., quantity, cluster data, individual workload characteristics, etc.) can be determined; and one or more characteristics of future hardware can be selected based at least in part on cluster data associated with the second subset. The second subset can include, for example, every workload of the plurality of anticipated workloads that is not in the first subset.

In some instances, a device allocation can include one or more times to execute a current workload 230. For example, in some instances, data associated with a current workload 230 can indicate that the workload is not latency-critical (e.g., can be performed any time in the next hour; day; week; etc.). In some instances, the current workload 230 can be scheduled for a time (e.g., off-peak time) when a preferred hardware device is expected to be available. In some instances, a current workload 230 can include two or more subcomponents (e.g., training iterations, minibatches, etc.) and the subcomponents can be scheduled to run at a same or a different time compared to each other. As a non-limiting illustrative example, a large machine learning training workload that is not time-critical may be scheduled for off-peak hours over a plurality of execution sessions (e.g., a few hours each night, etc.).

In some instances, device allocation system 228 can determine a new device allocation or changed device allocation in response to a change in the current workloads 230. For example, a computing system (e.g., device allocation system 228) can receive a request to execute a new workload that is not one of the current workloads 230. In some instances, the device allocation system 228 can automatically determine, responsive to receiving the request to execute the new workload, an appropriate hardware device to assign the new workload to. In some instances, the device allocation system 228 can output the assignment (e.g., to a user, to another computing device, etc.) or automatically route the new workload to the appropriate hardware device. In some instances, the assignment can be determined based at least in part on cluster data associated with the new workload, individual characteristics of the new workload, or comparative advantage data associated with the new workload.

In some instances, a device allocation can be based at least in part on a comparison between performance or hardware usage data (e.g., hardware usage profile 106 data) associated with a cluster or workload and one or more roofline parameters of one or more hardware devices. Roofline parameters can include, for example, maximum FLOPS, maximum HBM bandwidth, vector processing capacity, inter-chip communication capacity, etc. Roofline parameters can also include, for example, ratios between two or more other roofline parameters (e.g., operational intensity such as FLOPs/HBM bandwidth, FLOPs/ICI bandwidth, etc.)

In some instances, a device allocation can be based at least in part on a power usage of one or more current workloads 230. In some instances, determining a device allocation can include co-locating high-power workloads with low-power workloads, which can in some instances reduce a total amount of power that must be provisioned to a plurality of hardware devices.

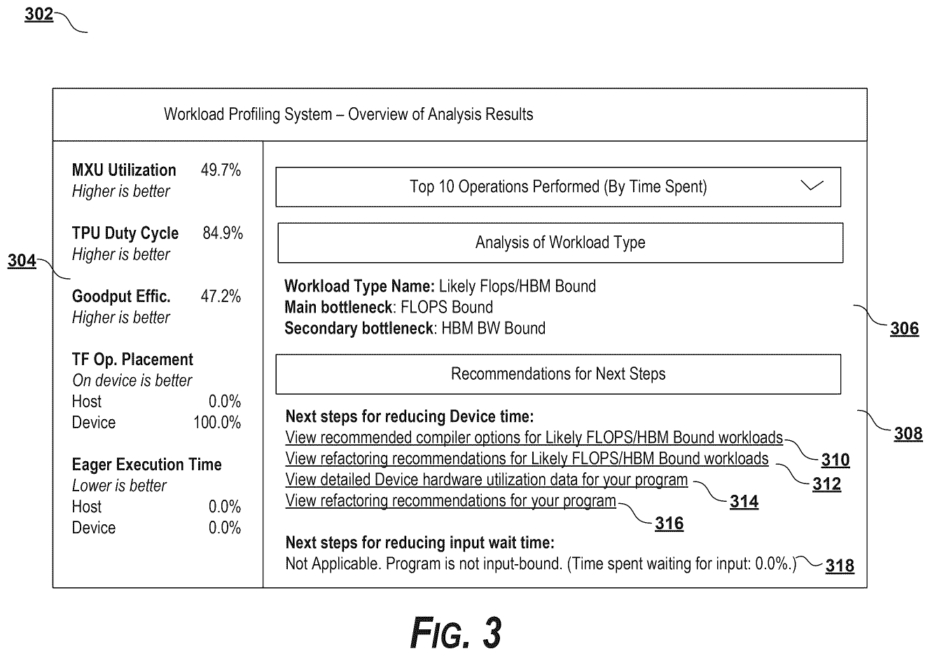

FIG. 3 illustrates an example user interface according to example implementations of aspects of the present disclosure. A workload profiling user interface 302 can provide a workload profile display 304, a workload cluster display 306, and a hardware allocation display 308. The hardware allocation display 308 can provide a plurality of hardware allocation recommendations 310, 312, 316 for improving a performance of a computational workload 102, 224, 226, 230.

A workload profiling user interface 302 can be, for example, a graphical user interface associated with a workload profiling system (e.g., software application, computing device, web application, etc.).

A workload profile display 304 can be, for example, a display component (e.g., window, frame, etc.) for displaying hardware usage profile 106 data (e.g., MXU utilization percentage, TPU duty cycle percentage, goodput efficiency, eager execution time, etc.) associated with a workload of interest (e.g., uncompiled workload 224 or compiled workload 226 provided by a user, current workload 230, etc.).

A workload cluster display 306 can be, for example, a display component (e.g., window, frame, etc.) for displaying workload cluster data associated with a workload of interest. The workload cluster data can include, for example, a cluster label (e.g., name, cluster identification number, etc.) and data indicative of one or more properties of the cluster (e.g., expected hardware bottlenecks, average or median hardware usage profile 106 data, hardware test data 218 or compiler test data 220, recommended compilation strategies, etc.).

A hardware allocation display 308 can be, for example, a display component (e.g., window, frame, etc.) for displaying one or more recommended hardware allocations (e.g., determined by a device allocation system 228, compilation system 222, testing system 216, etc.) or additional hardware usage profile data (e.g. detailed view, etc.) relevant to determining or selecting a hardware allocation associated with a workload of interest. Recommended hardware allocations can include cluster-based hardware allocation recommendations (e.g., cluster compiler recommendations 310, cluster refactoring recommendations 312, cluster device allocation recommendations, etc.) and recommendations specific to a particular workload (e.g., workload-specific compiler recommendations, workload-specific refactoring recommendations 316, workload-specific device allocation recommendations, etc.).

Cluster compiler recommendations 310 can include one or more compilation strategies for compiling a workload of interest. The cluster compiler recommendations 310 can be based at least in part on cluster data (e.g., hardware test data 218, compiler test data 220, hardware usage profile 106 data, etc.) associated with a cluster associated with the workload of interest. In some instances, the compiler recommendations 310 can include compilation strategies (e.g., compiler options, etc.) determined based at least in part on data (e.g., testing data 218, 220) associated with a representative benchmark 215 or other proxy workload. In some instances, the compiler recommendations 310 can include compilation strategies (e.g., compiler options, etc.) determined based at least in part on data (e.g., before-and-after performance data) associated with a plurality of compiled workloads 226 associated with a cluster associated with the workload of interest. Compilation strategies can include, for example, one or more compiler options, compiler settings, or compiler parameters; a choice of compiler in instances where more than one compiler is available; a script for running a compiler; etc.

In some instances, a workload profiling user interface 302 can display one or more workload-specific compiler recommendations. In some instances, workload-specific compiler recommendations can include compilation strategies (e.g., compiler options, etc.) determined based at least in part on cluster data (e.g., benchmark test data, before-and-after compilation data of a plurality of workloads, etc.) associated with the workload of interest. In some instances, workload-specific compiler recommendations can be based at least in part on one or more individual characteristics (e.g., scale, slice size, etc.) of an individual workload. In some instances, workload-specific compiler recommendations can be based at least in part on parameter sensitivity sweep data.

Cluster refactoring recommendations 312 and workload-specific refactoring recommendations 316 can include, for example, one or more recommendations for modifying a workload of interest to perform a similar (e.g., same) computational task or achieve a similar (e.g., same) computational outcome using different hardware. In some instances, refactoring recommendations can include suggestions to modify source code associated with the workload of interest. In some instances, refactoring recommendations can include suggestions to modify a machine-learning model associated with the workload of interest. For example, in some instances, a hardware device or hardware platform may be configured to optimally handle workloads of a particular scale (e.g., matrix multiplications using 128×128 square matrices, workloads using 256 or fewer TPUs or GPUs arranged in a 16×16 square configuration, etc.). In some instances, a small change to a characteristic (e.g., model size, etc.) of an individual workload may be associated with a sudden increase or decrease in cost (“cost cliff”) or performance, while other small changes may have little or no impact on performance. In some instances, a refactoring recommendation 312, 316 can include a recommendation to modify a workload to adjust a hardware usage of the workload (e.g., in ways that cannot be achieved through compilation and device allocation alone). In some instances, a refactoring recommendation 312, 316 can be determined based at least in part on cluster data (e.g., hardware usage profile 106 data, hardware testing data 218, compiler testing data 220, architecture sensitivity sweep data, etc.) and hardware device data. In some instances, workload-specific refactoring recommendations 316 can be based at least in part on one or more individual characteristics (e.g., scale, slice size, etc.) of an individual workload. In some instances, workload-specific refactoring recommendations 316 can be based at least in part on parameter sensitivity sweep data.

In some instances, a workload profiling user interface 302 can display detailed hardware usage data 314. Detailed hardware usage data 314 can include, for example, hardware usage profile 106 data associated with a workload of interest; cluster data (e.g., testing data 218, 220; hardware usage profile 106 data; etc.) associated with a cluster associated with the workload of interest; or any other relevant hardware usage data. In some instances, the workload profiling user interface 302 can curate detailed hardware usage data 314 by selecting detailed hardware usage data 314 that is relevant to a workload of interest or a cluster associated with the workload of interest. For example, a cluster or workload may be associated with one or more hardware bottlenecks, and the workload profiling user interface 302 can select data that is relevant for mitigating the hardware bottlenecks (e.g., reducing hardware usage associated with the bottlenecks, etc.) or data that is otherwise related to the one or more hardware bottlenecks.

In some instances, a workload profiling user interface 302 can display one or more do-nothing recommendations 318. For example, in instances where a workload does not have any bottlenecks associated with usage of a particular hardware type (e.g., infeed, high-bandwidth memory, etc.), then the workload profiling user interface 302 can indicate that a user should not focus any efforts on reducing a usage of that hardware type. As another example, in instances where an expected gain (e.g., return on investment, etc.) associated with improving a particular hardware allocation (e.g., compilation strategy, machine-learning model architecture, etc.) is below a predefined threshold, a do-nothing recommendation 318 can recommend not focusing any effort on improving that hardware allocation.

### Example Methods

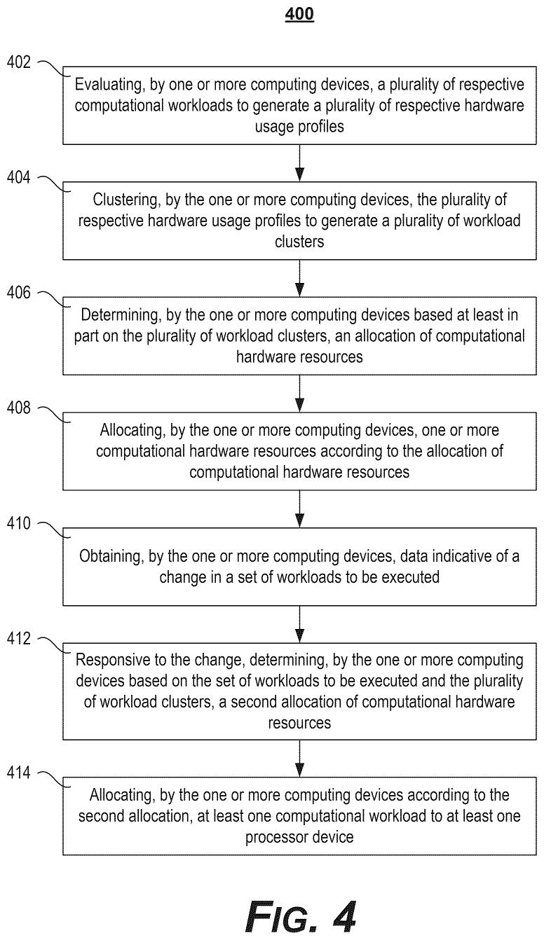

FIG. 4 depicts a flowchart diagram of an example method for allocating computational hardware resources according to example embodiments of the present disclosure. Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include evaluating, by one or more computing devices, a plurality of respective computational workloads to generate a plurality of respective hardware usage profiles. In some instances, a computational workload can be, comprise, or be comprised by a workload 102, uncompiled workload 224, compiled workload 226, current workload 230, or representative benchmark 215. In some instances, example method 400 at 402 can include using one or more systems or performing one or more activities described with respect to FIG. 1 or 2.

At 404, example method 400 can include clustering, by the one or more computing devices, the plurality of respective hardware usage profiles to generate a plurality of workload clusters. In some instances, a hardware usage profile can be, comprise, or be comprised by a hardware usage profile 106. In some instances, example method 400 at 404 can include using one or more systems or performing one or more activities described with respect to FIG. 1.

At 406, example method 400 can include determining, by the one or more computing devices based at least in part on the plurality of workload clusters, an allocation of computational hardware resources. In some instances, an allocation of computational hardware resources can be, comprise, or be comprised by a compilation strategy, hardware device allocation, or code refactoring recommendation. In some instances, example method 400 at 406 can include using one or more systems or performing one or more activities described with respect to FIGS. 1-3.

At 408, example method 400 can include allocating, by the one or more computing devices, one or more computational hardware resources according to the allocation of computational hardware resources. In some instances, allocating computational hardware resources can include compiling an uncompiled workload 224 to generate a compiled workload 226, or assigning a current workload 230 to a hardware device for executing the current workload 230. In some instances, example method 400 at 408 can include using one or more systems or performing one or more activities described with respect to FIG. 1 or 2.

At 410, example method 400 can include obtaining, by the one or more computing devices, data indicative of a change in a set of workloads to be executed. In some instances, a set of workloads to be executed can be, comprise, or be comprised by a set of current workloads 230. In some instances, example method 400 at 410 can include using one or more systems or performing one or more activities described with respect to FIGS. 1 to 3.

At 412, example method 400 can include determining, responsive to the change, by the one or more computing devices based on the set of workloads to be executed and the plurality of workload clusters, a second allocation of computational hardware resources. In some instances, an allocation of hardware resources can be, comprise, or be comprised by a compilation strategy, hardware device allocation, or code refactoring recommendation. In some instances, example method 400 at 412 can include using one or more systems or performing one or more activities described with respect to FIGS. 1 to 3.

At 414, example method 400 can include allocating, by the one or more computing devices according to the second allocation, at least one computational workload to at least one processor device (e.g., GPU, TPU, CPU, MXU, etc.). In some instances, example method 400 at 414 can include using one or more systems or performing one or more activities described with respect to FIG. 1 or 2.

### Example Computing Systems and Devices

FIG. 5 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 5 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 5 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65 , etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

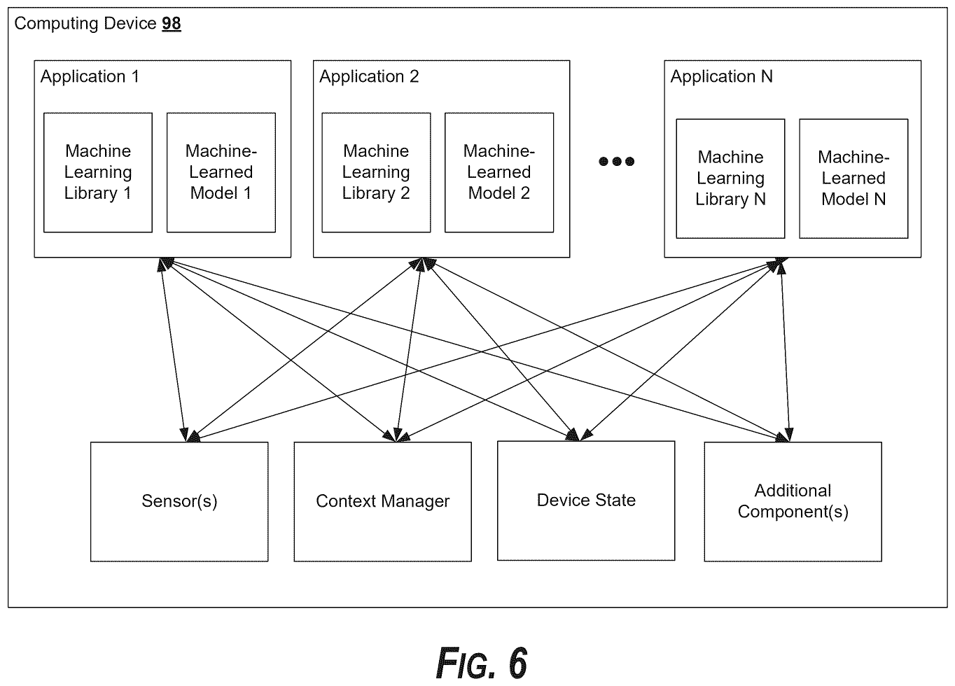

FIG. 6 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 6, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

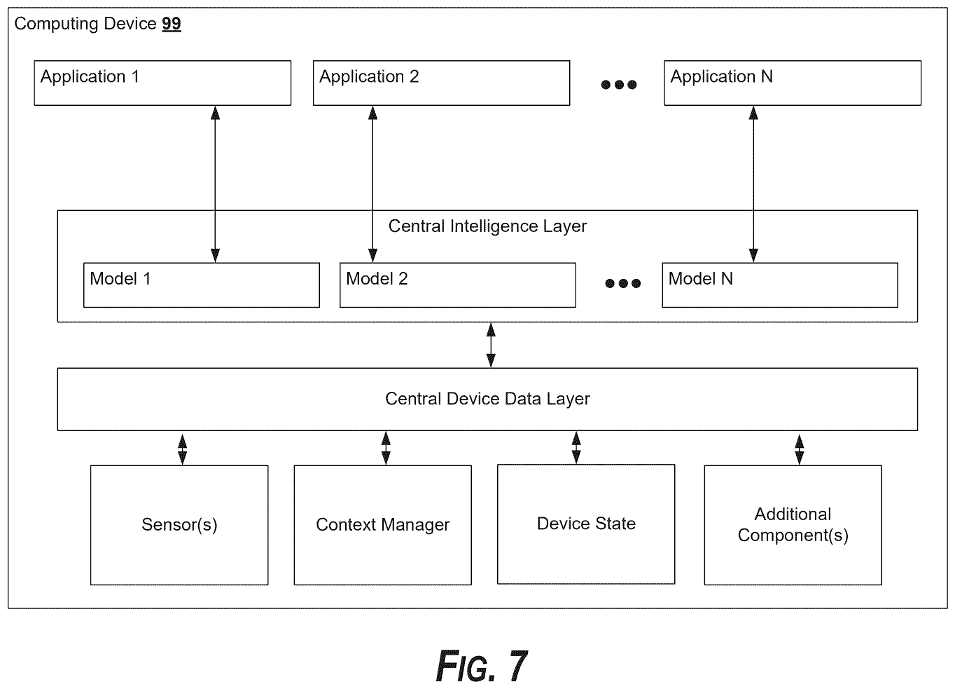

FIG. 7 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 7, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 7, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for optimizing fleet-level performance of computing resources, comprising:
evaluating, by one or more computing devices, a plurality of respective computational workloads to generate a plurality of respective hardware usage profiles;
clustering, by the one or more computing devices, the plurality of respective hardware usage profiles to generate a plurality of workload clusters; and
determining, by the one or more computing devices based at least in part on the plurality of workload clusters, an allocation of computational hardware resources.

2. The computer-implemented method of claim 1, further comprising outputting, by the one or more computing devices, data indicative of the allocation of computational hardware resources.

3. The computer-implemented method of claim 1, further comprising allocating, by the one or more computing devices, one or more computational hardware resources according to the allocation of computational hardware resources.

4. The computer-implemented method of claim 1, wherein the allocation of computational hardware resources comprises a mapping of a plurality of computational workloads to a plurality of processors.

5. The computer-implemented method of claim 4, wherein the plurality of processors comprises a plurality of application-specific integrated circuits.

6. The computer-implemented method of claim 4, wherein determining the mapping comprises:
obtaining, by the one or more computing devices, workload cluster data for a plurality of workloads;
obtaining, by the one or more computing devices, hardware availability data for a plurality of processors; and
determining, by the one or more computing devices based at least in part on the workload cluster data and the hardware availability data, the mapping.

7. The computer-implemented method of claim 4, wherein:
the mapping maps a first plurality of computational workloads to presently existing hardware and maps a second plurality of computational workloads to future hardware; and
further comprising:
determining, by the one or more computing devices based at least in part on one or more workload clusters associated with the second plurality of computational workloads, one or more hardware architecture requirements for running the second plurality of computational workloads.

8. The computer-implemented method of claim 4, further comprising:
obtaining, by the one or more computing devices, data indicative of a change in a set of workloads to be executed;
responsive to the change, determining, by the one or more computing devices based on the set of workloads to be executed and the plurality of workload clusters, a second allocation of computational hardware resources; and
allocating, by the one or more computing devices according to the second allocation, at least one computational workload to at least one processor device.

9. The computer-implemented method of claim 1, wherein the allocation of computational hardware resources comprises a compilation strategy for compiling one or more computational workloads.

10. The computer-implemented method of claim 9, further comprising:
obtaining, by the one or more computing devices, a second computational workload;
compiling, by the one or more computing devices, the second computational workload according to one or more first compilation strategies;
comparing, by the one or more computing devices, a performance of the compiled second computational workload to a performance associated with one or more second compilation strategies that are different from the one or more first compilation strategies; and
updating, by the one or more computing devices based on the comparison, the compilation strategy for compiling one or more computational workloads.

11. The computer-implemented method of claim 1, wherein the allocation of computational hardware resources comprises a scheduled time for running one or more computational workloads.

12. The computer-implemented method of claim 1, wherein the allocation of computational hardware resources comprises one or more hyperparameter settings associated with one or more computational workloads.

13. The computer-implemented method of claim 1, further comprising:
determining, by the one or more computing devices based at least in part on the plurality of workload clusters, a respective representative benchmark for each workload cluster of the plurality of workload clusters;
wherein the allocation of computational hardware resources is determined based at least in part on at least one respective representative benchmark.

14. The computer-implemented method of claim 13, further comprising:
parameterizing, by the one or more computing devices, at least one respective representative benchmark; and
performing, by the one or more computing devices based on the parameterized representative benchmark, one or more architectural sensitivity sweeps.

15. The computer-implemented method of claim 13, further comprising:
testing, by the one or more computing devices using at least one respective representative benchmark, a plurality of compilation strategies; and
selecting, by the one or more computing devices based on one or more results of the testing, a compilation strategy for at least one workload cluster associated with the at least one representative benchmark.

16. The computer-implemented method of claim 1, further comprising:
obtaining, by the one or more computing devices, a second computational workload;
evaluating, by the one or more computing devices, the second computational workload to generate a second workload profile;
determining, by the one or more computing devices based on the second workload profile and the plurality of workload clusters, a workload cluster associated with the second computational workload; and
outputting, based on the workload cluster associated with the second computational workload, one or more recommendations for improving a performance of the second computational workload.

17. The computer-implemented method of claim 1, wherein clustering the plurality of respective hardware usage profiles comprises:
performing, by the one or more computing devices, a first clustering action to generate a first plurality of workload clusters; and
performing, by the one or more computing devices based at least in part on the first plurality of workload clusters, a second clustering action to generate a second plurality of clusters.

18. The computer-implemented method of claim 1, wherein each respective hardware usage profile comprises at least one of:
a floating-point operations usage;
a memory bandwidth usage; and
a communication bandwidth usage associated with communication between two or more processor devices.

19. A computing system comprising one or more processors and one or more non-transitory computer-readable media storing instructions that are executable by the one or more processors to cause the computing system to perform operations, the operations comprising:
evaluating a plurality of respective computational workloads to generate a plurality of respective hardware usage profiles;
clustering the plurality of respective hardware usage profiles to generate a plurality of workload clusters; and
determining, based at least in part on the plurality of workload clusters, an allocation of computational hardware resources.

20. One or more non-transitory computer-readable media storing instructions that are executable by a computing system to perform operations, the operations comprising:
evaluating a plurality of respective computational workloads to generate a plurality of respective hardware usage profiles;
clustering the plurality of respective hardware usage profiles to generate a plurality of workload clusters; and
determining, based at least in part on the plurality of workload clusters, an allocation of computational hardware resources.
